(19) United States
(12) Patent Application Publication
(10) Pub. No.: US 2025/0053277 A1
(43) Pub. Date: Feb. 13, 2025

(54) AUGMENTING PRINT BOOKS WITH VIRTUAL REALITY AND EMOTION DETECTION MECHANISMS

(71) Applicant: INTERNATIONAL BUSINESS MACHINES CORPORATION, Armonk, NY (US)

(72) Inventors: Peng Hui Jiang, Beijing (CN); YONG QUAN TIAN, Beijing (CN); XI QING ZHANG, Bao Sheng Li (CN); Jun SU, Beijing (CN)

(21) Appl. No.: 18/447,101

(22) Filed: Aug. 9, 2023

(51) Int. Cl. G06F 3/0483; G06F 3/04815; G06F 40/169; G06T 17/00; G06V 40/16

(52) U.S. Cl. CPC G06F 3/0483; G06F 3/04815; G06F 40/169; G06T 17/00; G06V 40/174

(57) ABSTRACT

A computational device detects an emotion of a reader while reading a printed version of a book via a virtual reality device. A determination is made of notes made by other readers of the book with a similar emotion to the reader, where the notes have been stored in association with an electronic version of the book. The notes are displayed on a virtual reality interface of the virtual reality device to the reader.

### BACKGROUND

Embodiments relate to a method, system, and computer program product for augmenting print books with virtual reality and emotion detection mechanisms.

An electronic book, also known as an e-book or eBook, is a book publication made available in digital form. The electronic book may include any combination of text and images and may be read by using a computational device or specialized electronic book readers. Electronic books can be read on dedicated e-reader devices, but also on any computer device that features a controllable viewing screen, including desktop computers, laptops, tablets, and smartphones. Print books are books printed on paper and may also be referred to as printed books. A book may be published both as a print book and as an electronic book.

Virtual reality (VR) is a simulated experience that employs pose tracking and three-dimensional near-eye displays to provide the user an immersive feel of a virtual world. Currently, virtual reality systems may use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by virtual reality headsets comprising a head-mounted display with a small screen in front of the eyes.

### SUMMARY

Provided are a method, system, and computer program product in which a computational device detects an emotion of a reader while reading a printed version of a book via a virtual reality device. A determination is made of notes made by other readers of the book with a similar emotion to the reader, where the notes have been stored in association with an electronic version of the book. The notes are displayed on a virtual reality interface of the virtual reality device to the reader.

In additional embodiments, the computational device controls the virtual reality device to enable the reader to read the printed version of the book and the electronic version of the book simultaneously with the notes being highlighted on the virtual reality interface based on the emotion of the reader.

In further embodiments, new notes made by the reader on the printed version of the book are added to the electronic version of the book, where the new notes are associated with the emotion of the reader in the electronic version of the book.

In certain embodiments, the notes include comments and annotations made by the other readers while reading the printed version of the book or the electronic version of the book, where the notes enhance understanding of the book to the reader.

In further embodiments, different electronic versions of the book are generated from the notes of the other readers based on emotions of the other readers while reading the book.

In yet further embodiments, the computational device filters the notes corresponding to a request by the reader for additional content corresponding to a section of the printed version of the book, where filtered notes are those made by the other readers with the similar emotion to the reader.

In certain embodiments, reading experience of both the electronic version of the book and the printed version of the book are enhanced over reading the printed version of the book and the electronic version of the book separately without sharing the notes, where a personalized reading experience is provided to the reader.

### BRIEF DESCRIPTION OF THE DRAWINGS

Referring now to the drawings in which like reference numbers represent corresponding parts throughout:

FIG. 1 illustrates a block diagram of a computing environment for augmenting the reading of print books, in accordance with certain embodiments.

FIG. 2 illustrates a block diagram that shows the components of a software system for augmenting the reading of print books, in accordance with certain embodiments.

FIG. 3 illustrates a block diagram that shows a virtual reality connection with a print book, in accordance with certain embodiments.

FIG. 4 illustrates a block diagram that shows exemplary identifiable categories for emotions and mechanisms for detection of emotions, in accordance with certain embodiments.

FIG. 5 illustrates a block diagram that shows how content management is performed, in accordance with certain embodiments.

FIG. 6 illustrates a flowchart that shows how emotion matching is performed, in accordance with certain embodiments.

FIG. 7 illustrates a block diagram that shows rendering mechanisms, in accordance with certain embodiments.

FIG. 8 illustrates a block diagram that shows a print book to electronic book correspondence, in accordance with certain embodiments.

FIG. 9 illustrates a flowchart that shows first exemplary operations, in accordance with certain embodiments.

FIG. 10 illustrates a flowchart that shows second exemplary operations, in accordance with certain embodiments.

FIG. 11 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Currently, a book may be published both as a printed book and as an electronic book. Electronic books have many advantages. For example, electronic books are very portable because they can be read on various devices such as e-readers, tablets, and smartphones. Electronic books can also be stored in the cloud, which means an owner of the electronic book can synchronize and share books across different devices. Additionally, electronic books are usually cheaper than print books and may be purchased and downloaded online at any time.

On the other hand, printed books also have their own advantages. Printed books offer a unique reading experience with the tactile sensation, smell, and appearance of the paper. Printed books do not require batteries or charging and are not limited by electronic devices. Additionally, collecting and displaying printed books may become a source of enjoyment for many individuals.

Different readers may add comments and notes to both electronic books and printed books. However, generating connections between electronic books and a printed book is a challenging problem, especially because there may be multiple versions of electronic books and there may be a vast number of comments from readers with different emotions.

Currently, there are techniques to scan a printed book and match the contents to a corresponding electronic book. However, there is a need for other factors to be considered to increase accuracy and usability of such techniques.

Certain embodiments use virtual reality and emotion analysis mechanisms to share the notes or comments from the electronic book with readers who are reading the corresponding printed book and have similar emotions.

In certain embodiments a virtual reality application is used in conjunction with a virtual reality device to read printed books, and to detect the reader's emotions through facial recognition or other means.

Other embodiments create and manage multiple versions of an electronic book with notes added by readers with different emotions, where the notes may include comments and other annotations. The notes, comments, and annotations may be tagged according to the emotions they reflect.

Certain embodiments analyze the reader's emotions and match them with the appropriate electronic book version. In some embodiments, a virtual reality interface may be used to display the appropriate electronic book version along with the printed book, and highlight relevant notes, comments or annotations based on the reader's emotions.

Additional embodiments allow readers to add their own notes, comments, and annotations to the printed book and then save the printed book as an electronic book version through the virtual reality interface. These notes, comments and annotations may be tagged with the emotions of the reader.

Certain embodiments provide a social sharing feature that allows readers to share their notes, comments, and annotations with other readers who have similar emotions. Additionally, certain embodiments ensure that the virtual reality application and electronic book versions are regularly updated with new content and features based on reader feedback and usage patterns.

As a result of certain embodiments that match printed books to versions of electronic books, performance improvements are made in the operations of computing systems that enable the reading of printed books and electronic books via a virtual reality system.

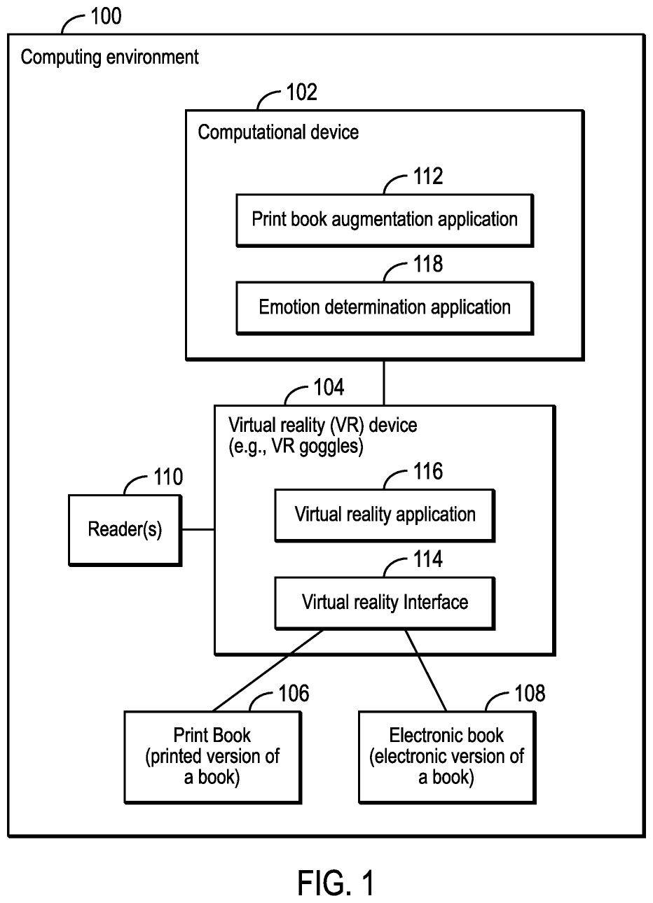

FIG. 1 illustrates a block diagram 100 of a computing environment for augmenting the reading of print books, in accordance with certain embodiments.

A computational device 102 controls a virtual reality device 104, where the virtual reality device 104 is used to display a print book 106 which is a printed version of a book and an electronic book 108 simultaneously to a reader 110, wherein the electronic book 108 is an electronic version of the print book 106.

In certain embodiments, computational device 102 in FIG. 1 may comprise any suitable computational device including those presently known in the art, such as, a personal computer, a workstation, a mainframe, a hand-held computer, a palm top computer, a head mounted computer, a telephony device, a network appliance, a blade computer, a processing device, a controller, etc. The virtual reality device 104 may include a virtual reality goggles, a head mounted device, or any other suitable virtual reality device known in the art. The elements shown in FIG. 1 may be in any suitable network, such as a storage area network, a wide area network, the Internet, an intranet, etc., or in a cloud computing environment.

A print book augmentation application 112 that executes in the computational device allows previously generated notes on contents of the print book 106 stored in the electronic book 108 corresponding to the print book 106 to be displayed on a virtual reality interface 114 of the virtual reality device 104. The print book augmentation application 112 may execute in coordination with a virtual reality application 116 that executes in the virtual reality device 104.

An emotion determination application 118 executes in the computational device 102. The emotion determination application 118 may determine the emotion of the reader while reading a book such as the print book 106 or the electronic book 108. A camera (not shown) coupled to the computational device 102 or the virtual reality device 104 may capture a video image of the reader 110 and the video image may be processed by the emotion determination application 118 to determine the emotion of the reader 110 while reading the print book 106 or the electronic book 108.

In certain embodiments, the emotions of a plurality of readers while reading print books and electronic books may be associated with the notes of the plurality of readers along with the emotions of the plurality of readers while generating the notes. The notes may be placed in association with sections of the electronic book 108 corresponding to the print book 106. The notes that were taken by other readers with a similar emotion to the reader may be displayed to the reader 110 while the reader 110 reads the print book 106 via the virtual reality device 104.

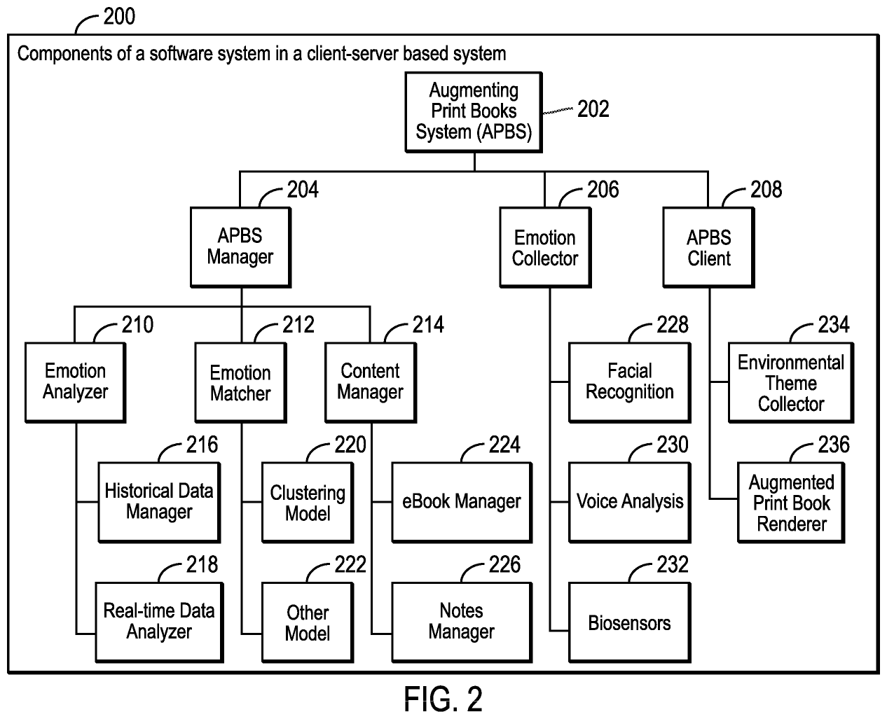

FIG. 2 illustrates a block diagram 200 that shows the components of a software system for augmenting the reading of print books in a client-server based system, in accordance with certain embodiments. The components shown in FIG. 2 may be implemented in a client-server system where certain operations of the print book augmentation application 112, the emotion determination application 118, and the virtual reality application 116 are performed in a server and certain operations in a client, whereas in FIG. 1, the operations are shown to occur in the computational device 102 and the virtual reality device 104.

A software system referred to as an “Augmenting Print Books System” (APBS) 202 may be comprised of an APBS manager 204, an emotion collector 206, and an APBS client 208.

The APBS manager 204 may be comprised of an emotional analyzer 210, an emotion matcher 212, and a content manager 214. The emotion analyzer 210 may include a historical data manager 216 for managing data related to reader emotions in the past and a real-time data analyzer 218 for managing data related to reader emotions at the time when one or more readers are reading a book. The emotion matcher 212 may use a clustering model 220 or other models 222 to match the emotion of a reader to other emotions previously acquired for a group of readers to determine whether the emotion of the reader is similar to an emotion previously acquired for a group of readers. The content manager 214 may include an electronic book manager referred to as an eBook manager 224 for managing the text of an electronic book and a notes manager 226 for managing the notes by readers on various sections of the electronic book. The emotion collector 206 may use facial recognition 228, voice analysis 230, and various biosensors 232 to collect the emotions of readers. The APBS client 208 may include an environmental theme collector 234 to determine the environment of the reader and an augmented print book renderer 236 to render the print book in the virtual reality device.

It should be noted that the components shown in FIG. 2 may be configured in many different ways and additional components may be used in alternative embodiments. Additionally, multiple components shown in FIG. 2 may be consolidated into a single component.

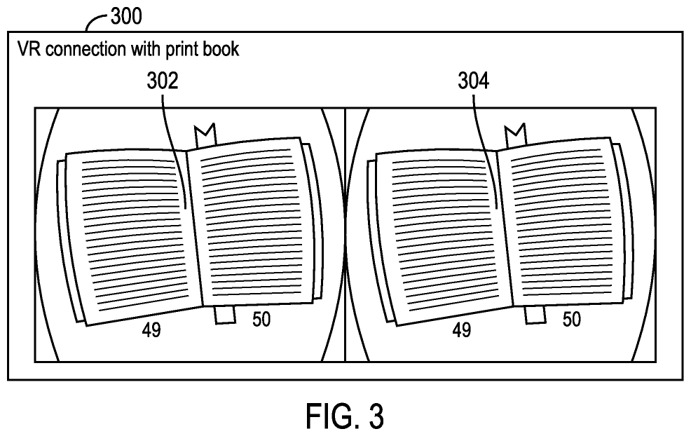

FIG. 3 illustrates a block diagram 300 that shows a virtual reality connection with a print book, in accordance with certain embodiments. Two versions 302 and 304 as displayed on the interface of a virtual reality device are shown in FIG. 3.

In certain embodiments a virtual reality application is used in conjunction with a virtual reality device to read a print book. For example, a reader may use a virtual reality device 104 and a compatible virtual reality application 116 that supports the reading of print books.

Certain embodiments use the virtual reality application 112, the print book augmentation application 112, and the emotion determination application 118 to monitor the behavior of readers and the actions of readers with respect to the print book. Mechanisms may be provided for adjusting the settings, including the text size or font and for assisting in emotion detection.

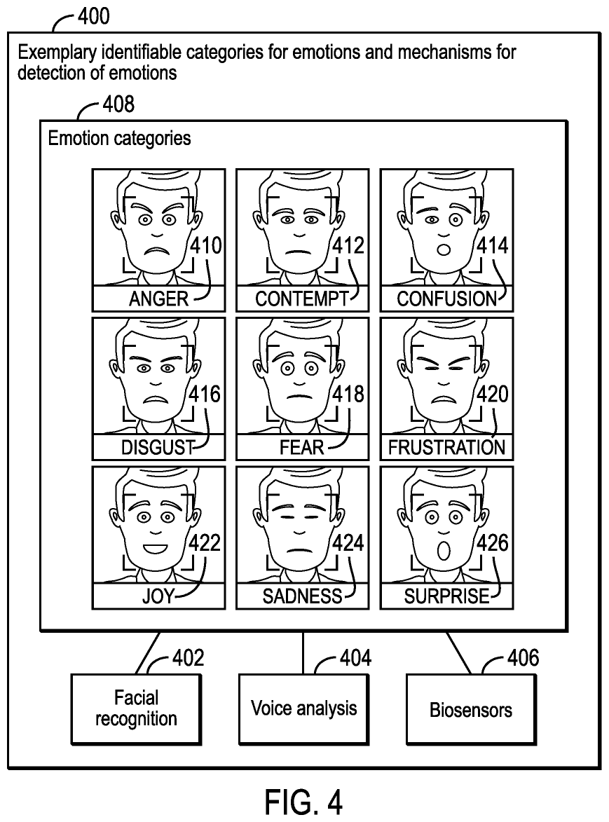

FIG. 4 illustrates a block diagram 400 that shows exemplary identifiable categories for emotions and mechanisms for detection of emotions, in accordance with certain embodiments.

Certain embodiments detect the reader's emotions through facial recognition 402 or other means. For example, one common technique for detecting emotions is to use facial recognition software, which can analyze the microexpressions and muscle movements on a person's face to determine their emotional state. This can involve tracking specific features such as eyebrow movements, eye widening or squinting, and lip curvature.

Voice analysis 404 is a technique to analyze a person's voice, and may provide clues about their emotional state based on factors such as pitch, tone, and volume. For example, a high-pitched, trembling voice may indicate fear or anxiety, while a low, steady voice may indicate calmness or confidence.

In certain embodiments, emotion detection software may use biosensors 406 to measure physiological signals such as heart rate, skin conductance, or respiration rate. These signals can provide information about a person's level of relaxation or stress, which can be used to infer their emotional state.

Certain exemplary categories 408 of emotions such as anger 410, contempt 412, confusion 414, disgust 416, fear 418, frustration 420, joy 422, sadness 424, and surprise 426 are shown in FIG. 4 as determined from facial recognition 402, voice analysis 404, and biosensors 406. Though this disclosure pertains to the collection of personal data (e.g., facial image data, voice data, microexpressions, muscle movements, eye and lip movements, emotion data, etc.), it is noted that in embodiments, users opt into the system. In doing so, users are informed of what data is collected and how it will be used, that any collected personal data may be encrypted while being used, that the users can opt-out at any time, and that if they opt out, any personal data of the user is deleted.

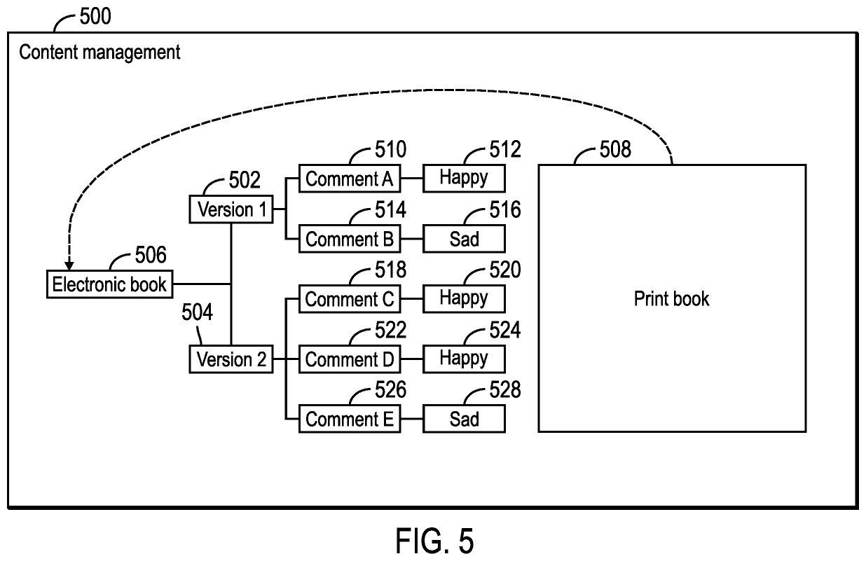

FIG. 5 illustrates a block diagram 500 that shows how content management is performed, in accordance with certain embodiments.

Certain embodiments create and manage multiple versions of an electronic book with notes such as comments that are added by readers with different emotions. The system may tag the comments according to the emotions they reflect.

For example, FIG. 5 shows two versions 502, 504 of an electronic book 506 corresponding to a print book 508. In the first version 502 of the electronic book, comment A 510 was made when the reader was happy 512 and comment B 514 was made when the reader was sad 516. In the second version 504 of the electronic book, comment C 518 was made when the reader was happy 520, comment D 522 was made when the reader was happy 524, and comment E 526 was made when the reader was sad 528.

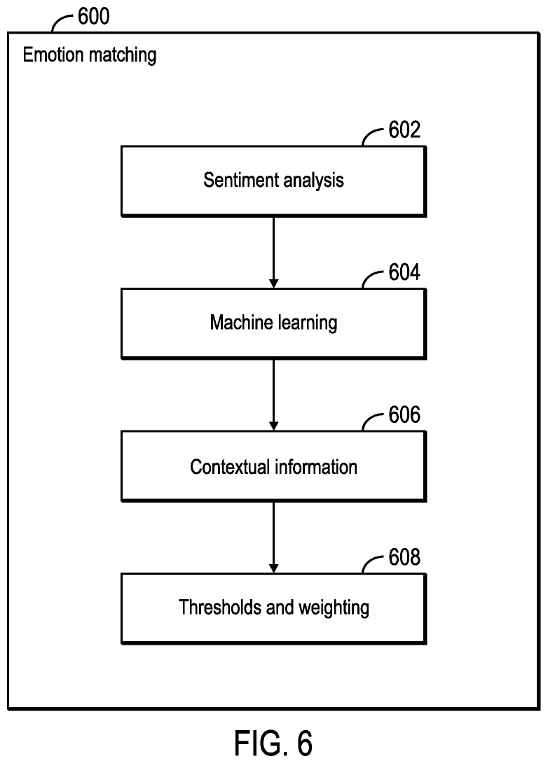

FIG. 6 illustrates a flowchart 600 that shows how emotion matching is performed, in accordance with certain embodiments.

Control starts at block 602 where sentiment analysis is performed. Sentiment analysis may use natural language processing (NLP) techniques to identify and extract emotional information from text. Sentiment analysis algorithms can analyze the text of the notes and comments in the electronic book to identify the emotional tone of the content, such as whether it is positive, negative, or neutral.

From block 602 control proceeds to block 604 where machine learning algorithms are used to match the reader's detected emotions with the emotions of the notes in the electronic book. This may involve training a machine learning model on a dataset of emotions associated with different types of content, such as news articles or social media posts, and then using that model to predict the emotional tone of the notes in the electronic book.

From block 604 control process to block 606 where contextual information is used to improve the accuracy of the emotion matching mechanisms. Contextual information such as the genre, topic, or author of the book may be taken into account. For example, a horror novel may have different emotional tones compared to a romance novel, so based on the contextual information the operations may adjust its predictions.

From block 606 control proceeds to block 608 where thresholds and weighting may be used to determine which notes are most relevant to the reader's emotional state. For example, notes that are highly positive or negative may be given more weight than those that are more neutral, and only notes that match the reader's detected emotions above a certain threshold may be shown.

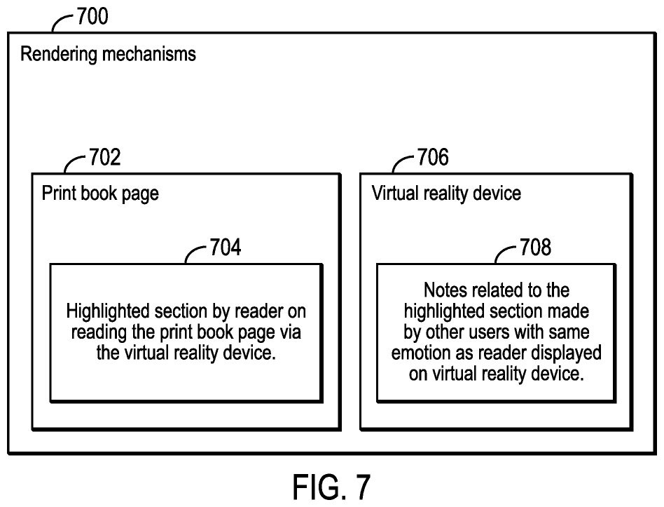

FIG. 7 illustrates a block diagram 700 that shows rendering mechanisms, in accordance with certain embodiments.

FIG. 7 shows how to use the virtual reality interface to display the appropriate electronic book version along with the print book, and highlight relevant notes or comments based on the reader's emotions.

The reader highlights a section 704 of a print book page 702 on reading the print book page via the virtual reality device. The notes 708 related to the highlighted section made by other users with the same emotion as the reader are displayed on the virtual reality device 706.

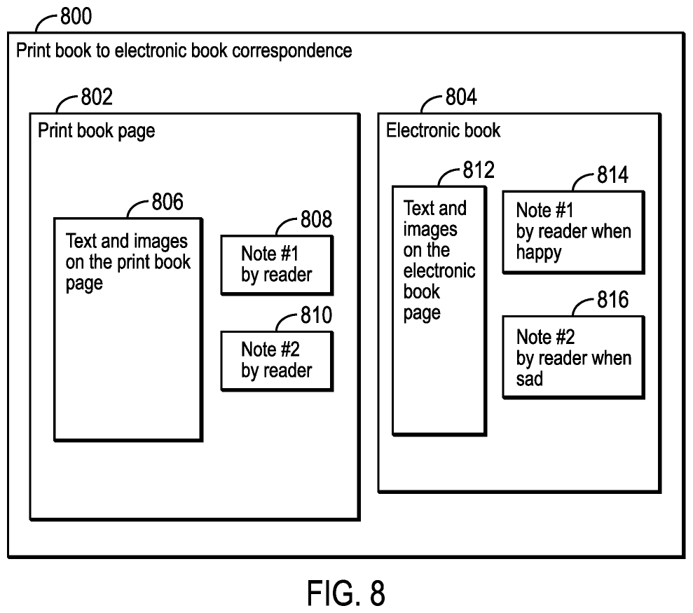

FIG. 8 illustrates a block diagram 800 that shows a print book to electronic book correspondence, in accordance with certain embodiments.

The embodiments allow readers to add their own notes and comments to the print book and then save as electronic version through the virtual reality interface. These notes are tagged with the reader's emotions.

For example, a print book page 802 and a corresponding electronic book page 804 are shown. The text and images on the print book page 806 are augmented by the reader by handwriting note #1 808 and note #2. The emotions of the reader while writing the notes on the print book are analyzed and in the corresponding portion of the text and images on the electronic book page 812, information of note #1 is maintained indicating that note #1 was made when the reader was happy (shown via reference numeral 814), and information on note #2 is maintained indicating that note #2 was made when the reader was sad (shown via reference numeral 816).

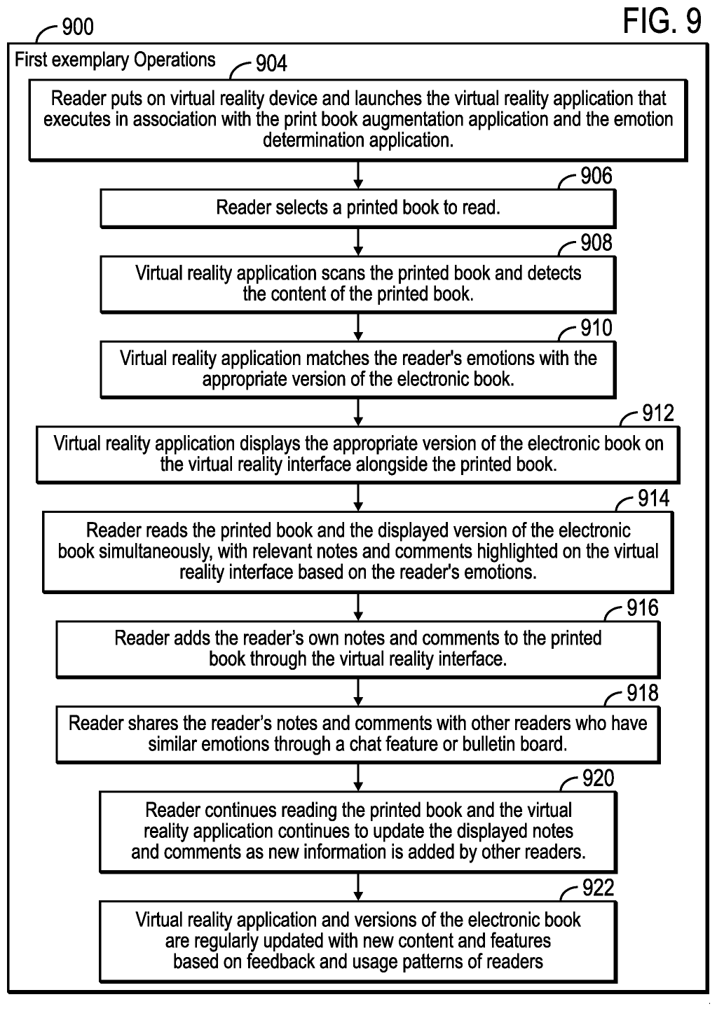

FIG. 9 illustrates a flowchart 900 that shows first exemplary operations, in accordance with certain embodiments.

Control starts at block 904 in which a reader puts on virtual reality device and launches the virtual reality application 116 that executes in association with the print book augmentation application 112 and the emotion determination application 118. The reader selects (at block 906) a printed book to read. The virtual reality application scans (at block 908) the printed book and detects the content of the printed book. The virtual reality application matches (at block 910) the reader's emotions with the appropriate version of the electronic book.

From block 910 control proceeds to block 912 in which the virtual reality application displays the appropriate version of the electronic book on the virtual reality interface alongside the printed book. The reader reads (at block 914) the printed book and the displayed version of the electronic book simultaneously, with relevant notes and comments highlighted on the virtual reality interface based on the reader's emotions. The reader adds (at block 916) the reader's own notes and comments to the printed book through the virtual reality interface.

From block 916 control proceeds to block 918 in which the reader shares the reader's notes and comments with other readers who have similar emotions through a chat feature or bulletin board. The reader continues (at block 920) reading the printed book and the virtual reality application continues to update the displayed notes and comments as new information is added by other readers. The virtual reality application and versions of the electronic book are regularly updated (at block 922) with new content and features, based on feedback and usage patterns of readers.

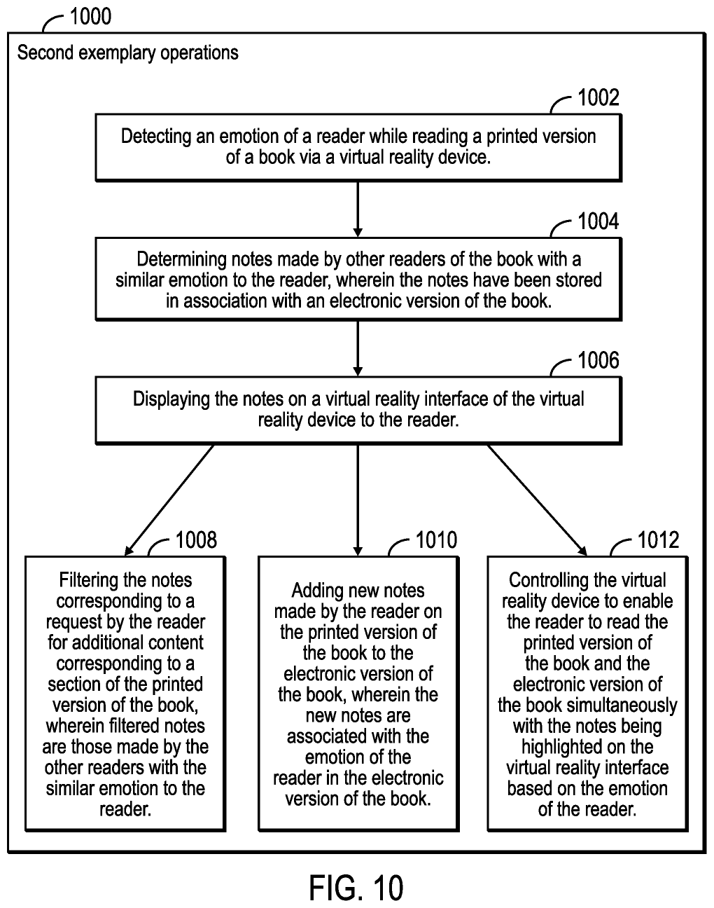

FIG. 10 illustrates a flowchart 1000 that shows second exemplary operations, in accordance with certain embodiments.

Control starts at block 1002 in which a computational device detects an emotion of a reader while reading a printed version of a book via a virtual reality device. A determination is made (at block 1004) of notes made by other readers of the book with a similar emotion to the reader, where the notes have been stored in association with an electronic version of the book. The determination of other readers with a similar emotion to the reader may be performed by the emotion matcher 212 that uses a clustering model 220 or other models 222 (as shown in FIG. 2) and the categories of emotions shown in FIG. 4. The notes are displayed (at block 1006) on a virtual reality interface of the virtual reality device to the reader.

From block 1006 control may proceed in parallel to blocks 1008, 1010, and 1012. At block 1008, the computational device filters the notes corresponding to a request by the reader for additional content corresponding to a section of the printed version of the book, where filtered notes are those made by the other readers with the similar emotion to the reader.

At block 1010, new notes made by the reader on the printed version of the book are added to the electronic version of the book, where the new notes are associated with the emotion of the reader in the electronic version of the book.

At block 1012 the computational device controls the virtual reality device to enable the reader to read the printed version of the book and the electronic version of the book simultaneously with the notes being highlighted on the virtual reality interface based on the emotion of the reader.

Therefore, FIGS. 1-10 illustrate embodiments for print book augmentation mechanism that enhances the reading experience of a reader. Using a virtual reality device to read a print book enhances the reading experience by providing a more immersive and interactive environment for the reader. The ability of the virtual reality device to detect the reader's emotions can help to personalize the reading experience, allowing the reader to better connect with the material and potentially gain new insights into their emotional responses. The multiple versions of the associated electronic book, with notes and comments added by readers with different emotional responses provide a rich source of additional content that can enhance the reader's understanding and appreciation of the book. Using an algorithm to match the reader's detected emotions with the emotions of the notes and comments can help in providing the most relevant and meaningful content for the reader, further enhancing their experience. By sharing the notes and comments from the electronic book with readers who have similar emotions, the reading experience becomes more social and collaborative, allowing readers to benefit from the insights and thoughts of others who have read the book and have had similar emotional responses.

There are several advantages to using this approach of connecting an electronic book and a print book with virtual reality technology. The virtual reality technology provides an immersive reading experience that can enhance the reading experience for both the print book and electronic book. By synchronizing notes between the print book and electronic book, a reader is able consolidate their notes in one place, making it easier to review and access them later. If there is a print book and electronic book version of the same text, then a reader can use the virtual reality technology to access the electronic book notes while reading the print book, making it easier to review the notes. This approach allows for personalization of the reading experience, as reader can take and synchronize their own notes or view notes taken by others. The ability to take notes in both the print book and electronic book, and synchronize them between the two, can increase productivity and efficiency in studying or research.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

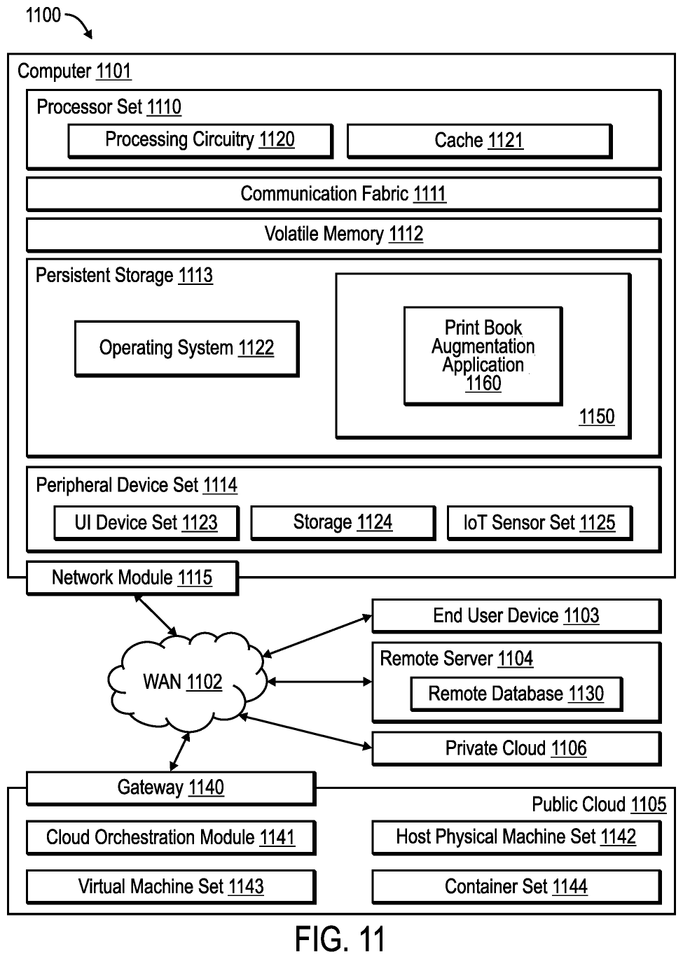

In FIG. 11, computing environment 1100 contains an example of an environment for the execution of at least some of the computer code (block 1150) involved in performing the operations of print book augmentation application 1160 that performs operations shown in FIGS. 1-10.

In addition to block 1150, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1150, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1150 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface-type operating systems that employ a kernel. The code included in block 1150 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. I/O T sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The letter designators, such as i, is used to designate a number of instances of an element and may indicate a variable number of instances of that element when used with the same or different elements.

The terms “an embodiment”, “embodiment”, “embodiments”, “the embodiment”. “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method performed by a computational device, the method comprising:
detecting an emotion of a reader while reading a printed version of a book via a virtual reality device;
determining notes made by other readers of the book with a similar emotion to the reader, wherein the notes have been stored in association with an electronic version of the book; and
displaying the notes on a virtual reality interface of the virtual reality device to the reader.

2. The method of claim 1, the method further comprising:
controlling the virtual reality device to enable the reader to read the printed version of the book and the electronic version of the book simultaneously with the notes being highlighted on the virtual reality interface based on the emotion of the reader.

3. The method of claim 1, the method further comprising:
adding new notes made by the reader on the printed version of the book to the electronic version of the book, wherein the new notes are associated with the emotion of the reader in the electronic version of the book.

4. The method of claim 1, wherein the notes include comments and annotations made by the other readers while reading the printed version of the book or the electronic version of the book, and wherein the notes enhance understanding of the book to the reader.

5. The method of claim 1, wherein different electronic versions of the book are generated from the notes of the other readers based on emotions of the other readers while reading the book.

6. The method of claim 1, the method further comprising:
filtering the notes corresponding to a request by the reader for additional content corresponding to a section of the printed version of the book, wherein filtered notes are those made by the other readers with the similar emotion to the reader.

7. The method of claim 1, wherein reading experience of both the electronic version of the book and the printed version of the book are enhanced over reading the printed version of the book and the electronic version of the book separately without sharing the notes, and wherein a personalized reading experience is provided to the reader.

8. A system, comprising:
a memory; and
a processor coupled to the memory, wherein the processor performs operations, the operations comprising:
detecting an emotion of a reader while reading a printed version of a book via a virtual reality device;
determining notes made by other readers of the book with a similar emotion to the reader, wherein the notes have been stored in association with an electronic version of the book; and
displaying the notes on a virtual reality interface of the virtual reality device to the reader.

9. The system of claim 8, the operations further comprising:
controlling the virtual reality device to enable the reader to read the printed version of the book and the electronic version of the book simultaneously with the notes being highlighted on the virtual reality interface based on the emotion of the reader.

10. The system of claim 8, the operations further comprising:
adding new notes made by the reader on the printed version of the book to the electronic version of the book, wherein the new notes are associated with the emotion of the reader in the electronic version of the book.

11. The system of claim 8, wherein the notes include comments and annotations made by the other readers while reading the printed version of the book or the electronic version of the book, and wherein the notes enhance understanding of the book to the reader.

12. The system of claim 8, wherein different electronic versions of the book are generated from the notes of the other readers based on emotions of the other readers while reading the book.

13. The system of claim 8, the operations further comprising:
filtering the notes corresponding to a request by the reader for additional content corresponding to a section of the printed version of the book, wherein filtered notes are those made by the other readers with the similar emotion to the reader.

14. The system of claim 8, wherein reading experience of both the electronic version of the book and the printed version of the book are enhanced over reading the printed version of the book and the electronic version of the book separately without sharing the notes, and wherein a personalized reading experience is provided to the reader.

15. A computer program product, the computer program product comprising a computer readable storage medium having computer readable program code embodied therewith, the computer readable program code when executed is configured to perform operations, the operations comprising:
detecting an emotion of a reader while reading a printed version of a book via a virtual reality device;
determining notes made by other readers of the book with a similar emotion to the reader, wherein the notes have been stored in association with an electronic version of the book; and
displaying the notes on a virtual reality interface of the virtual reality device to the reader.

16. The computer program product of claim 15, the operations further comprising:
controlling the virtual reality device to enable the reader to read the printed version of the book and the electronic version of the book simultaneously with the notes being highlighted on the virtual reality interface based on the emotion of the reader.

17. The computer program product of claim 15, the operations further comprising:
adding new notes made by the reader on the printed version of the book to the electronic version of the book, wherein the new notes are associated with the emotion of the reader in the electronic version of the book.

18. The computer program product of claim 15, wherein the notes include comments and annotations made by the other readers while reading the printed version of the book or the electronic version of the book, and wherein the notes enhance understanding of the book to the reader.

19. The computer program product of claim 15, wherein different electronic versions of the book are generated from the notes of the other readers based on emotions of the other readers while reading the book.

20. The computer program product of claim 15, the operations further comprising:
filtering the notes corresponding to a request by the reader for additional content corresponding to a section of the printed version of the book, wherein filtered notes are those made by the other readers with the similar emotion to the reader.
